(19) United States
(12) Patent Application Publication
(10) Pub. No.: US 2015/0048593 A1
(43) Pub. Date: Feb. 19, 2015

(54) Backward Wheelchair

(71) Applicant: Chin-Hsing Tsai, Changhua City (TW)

(72) Inventor: Chin-Hsing Tsai, Changhua City (TW)

(21) Appl. No.: 13/965,279

(22) Filed: Aug. 13, 2013

(51) Int. Cl. A61G 5/10

(52) U.S. Cl. CPC A61G 5/10
USPC 280/304.1

(57) ABSTRACT

A backward wheelchair contains two side-frame units, a seat support, and a back support. The two side-frame units are symmetrical and spaced apart, between the two side-frame units is connected a first connecting rod, each side-frame unit includes an auxiliary wheel, each side frame has a main wheel with a manual operating wheel, an armrest, and a handle. The seat support includes an elongated body connecting with a seat portion and is fixed between the two side-frame units, a width of the seat support is less than a distance between the two side-frame units. The backward wheelchair further contains a gate formed on a rear side thereof, and among the seat support and the two side-frame units are defined two passage spaces. The back support is fixed between the two side-frame units so as to facilitate a movement of a patient, and the patient's back contacts with the back support.

### BACKGROUND OF THE INVENTION

1. Field of the Invention

The present invention relates to a wheelchair, and more particularly to a backward wheelchair which helps a patient having paraplegia or hemiplegia to move easily.

2. Description of the Prior Art

A conventional wheelchair is applied to assist a patient having paraplegia or hemiplegia to move and/or to sit, so the patient enters and sits on the wheelchair from a front side of the wheelchair. When desiring to move to the wheelchair from a bed or to move to the bed from the wheelchair, the patient has to request for someone's help. Therefore, it is not convenient for the patient to move to the bed or the wheelchair.

The present invention has arisen to mitigate and/or obviate the afore-described disadvantages.

### SUMMARY OF THE INVENTION

The primary object of the present invention is to provide a backward wheelchair in which a back side of the backward wheelchair is contacted with a bed or a chair, and then a patient holds two armrests of two side-frame units so as to easily move to the backward wheelchair from the bed or the chair easily via a gate and two passage spaces.

Another object of the present invention is to provide a backward wheelchair in which the back side of the backward wheelchair is contacted with the bed or the chair, and then a patient holds the two armrests of the two side-frame units so as to move to the bed or the chair from the backward wheelchair via the gate and the two passage spaces easily.

To obtain the above objectives, a backward wheelchair contains: two side-frame units, a seat support, and a back support.

The two side-frame units are symmetrical and spaced a distance apart, between the two side-frame units is connected a first connecting rod, each side-frame unit includes an auxiliary wheel mounted proximate to a lower side of a front end of each side frame, each side frame has a main wheel disposed adjacent to a rear end thereof, and the main wheel has a manual operating wheel, each side frame further has an armrest mounted on an upper side of the rear end thereof and a handle extending upwardly from the rear end thereof.

The seat support includes an elongated body connecting with a seat portion, the seat support is fixed between the two side-frame units, a width of the seat support is less than the distance between the two side-frame units, the backward wheelchair further contains a gate formed on a rear side thereof, among the seat support and the two side-frame units are defined two passage spaces.

The back support is fixed or rotated between the two side-frame units so as to facilitate a movement of a patient, and the patient's back contacts with the back support.

### BRIEF DESCRIPTION OF THE DRAWINGS

FIG. 1 is a perspective view showing the exploded components of a backward wheelchair according to a preferred embodiment of the present invention.

FIG. 1A is an amplified perspective view of a part of FIG. 1.

FIG. 1B is an amplified perspective view of another part of FIG. 1.

FIG. 2 is another perspective view showing the exploded components of the backward wheelchair according to the preferred embodiment of the present invention.

FIG. 3 is a perspective view showing the assembly of the backward wheelchair according to the preferred embodiment of the present invention.

FIG. 4 is another perspective view showing the assembly of the backward wheelchair according to the preferred embodiment of the present invention.

FIG. 5 is a top plan view showing the assembly of the backward wheelchair according to the preferred embodiment of the present invention.

FIG. 6 is a back plan view showing the assembly of the backward wheelchair according to the preferred embodiment of the present invention.

FIG. 7 is a perspective view showing the operation of the backward wheelchair according to the preferred embodiment of the present invention.

FIG. 8 is another perspective view showing the operation of the backward wheelchair according to the preferred embodiment of the present invention.

FIG. 9 is also another perspective view showing the operation of the backward wheelchair according to the preferred embodiment of the present invention.

FIG. 10 is still another perspective view showing the operation of the backward wheelchair according to the preferred embodiment of the present invention.

FIG. 11 is a top plan view showing the operation of the backward wheelchair according to the preferred embodiment of the present invention.

FIG. 12 is a perspective view showing the assembly of the backward wheelchair according to another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

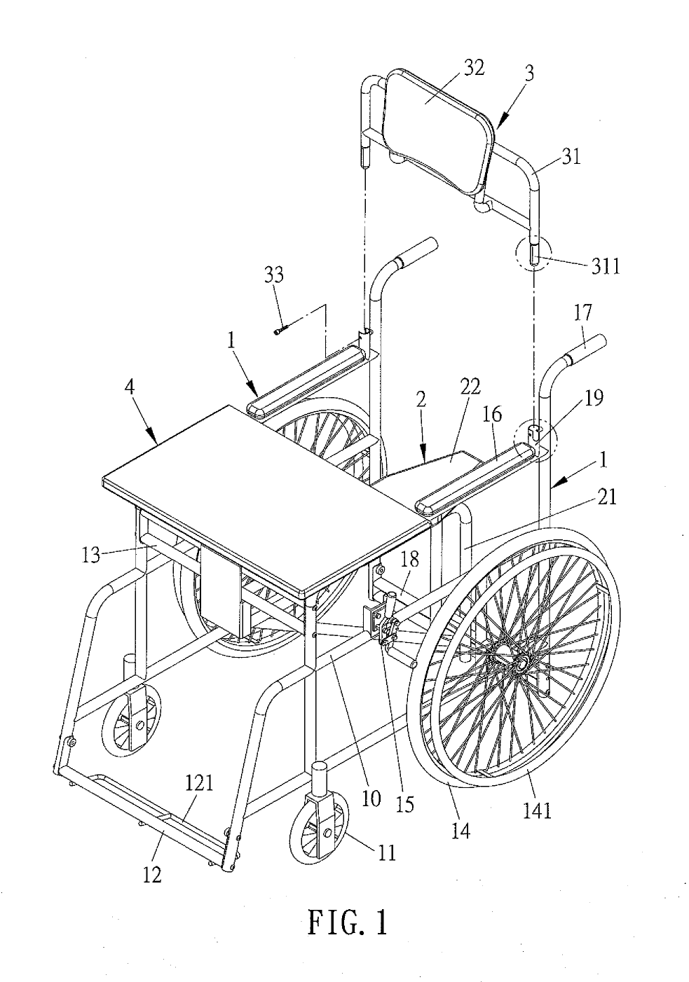

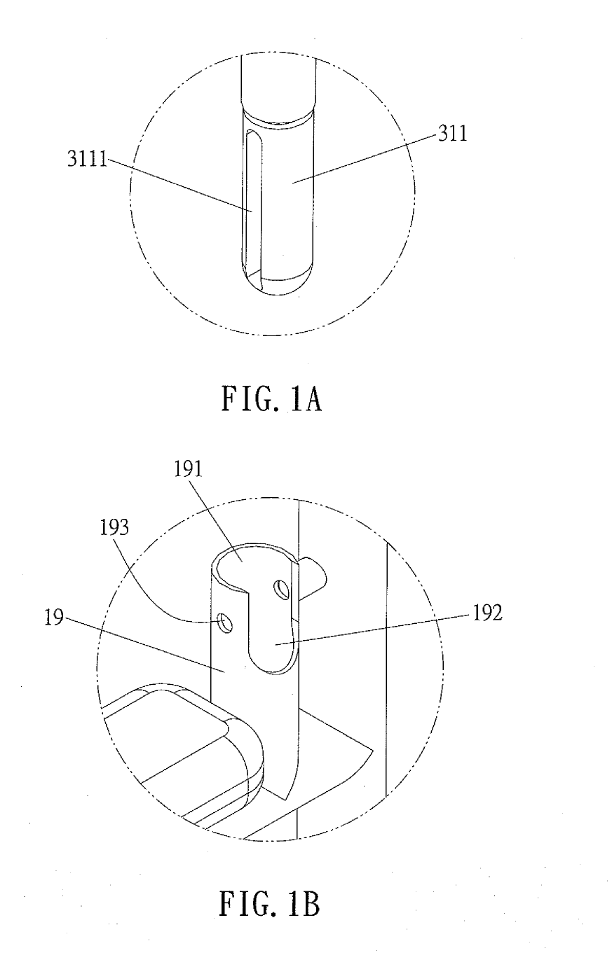

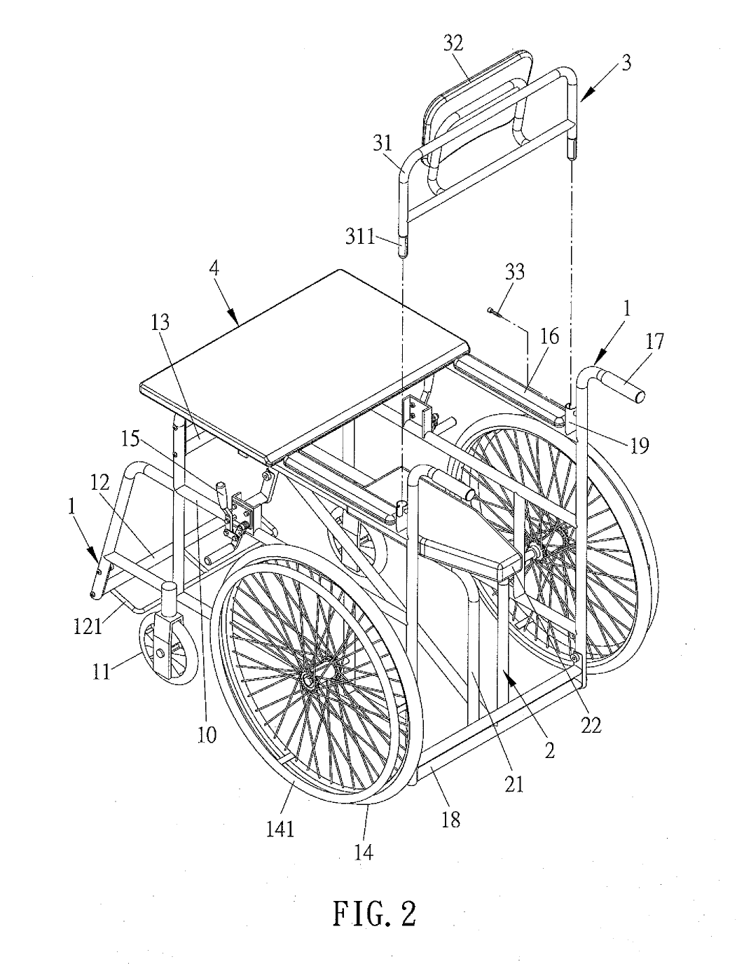

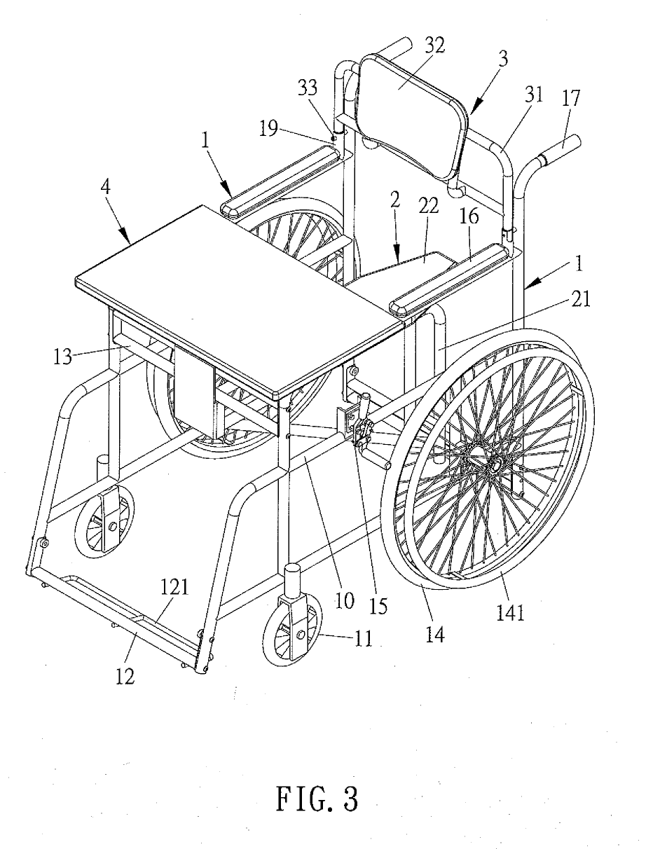

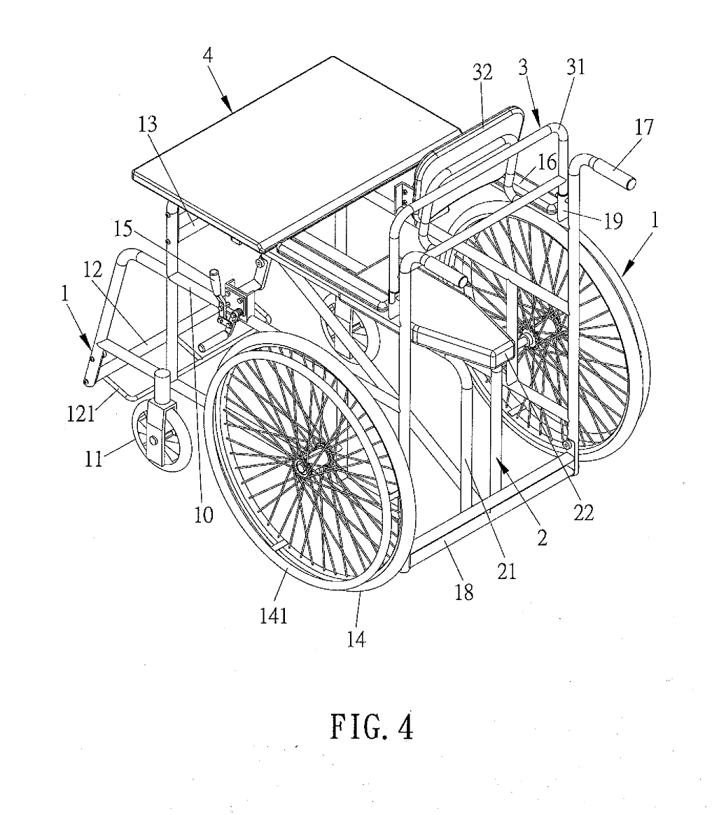

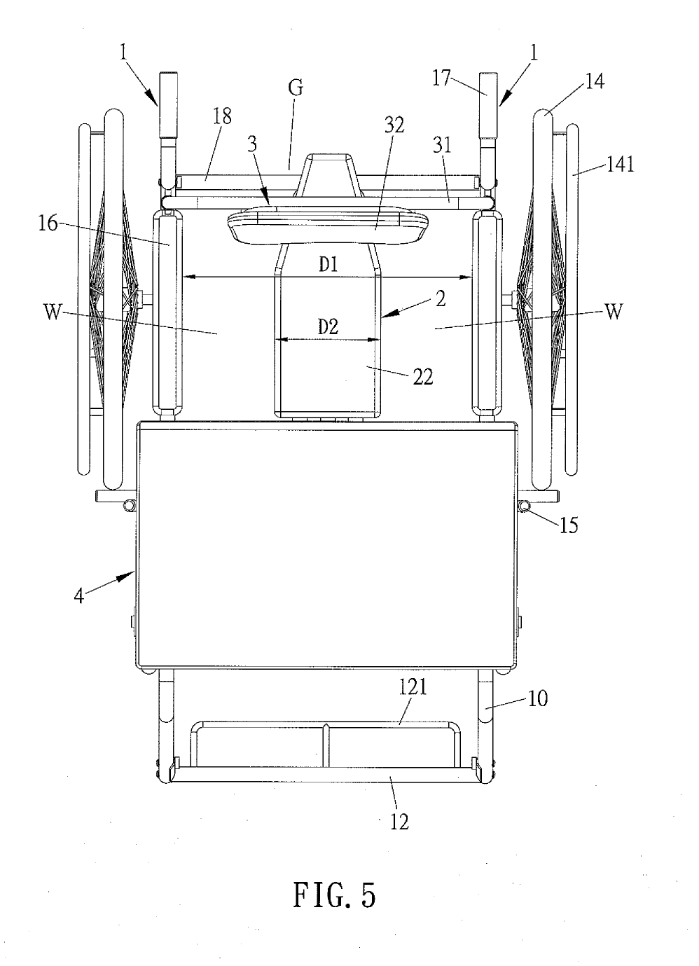

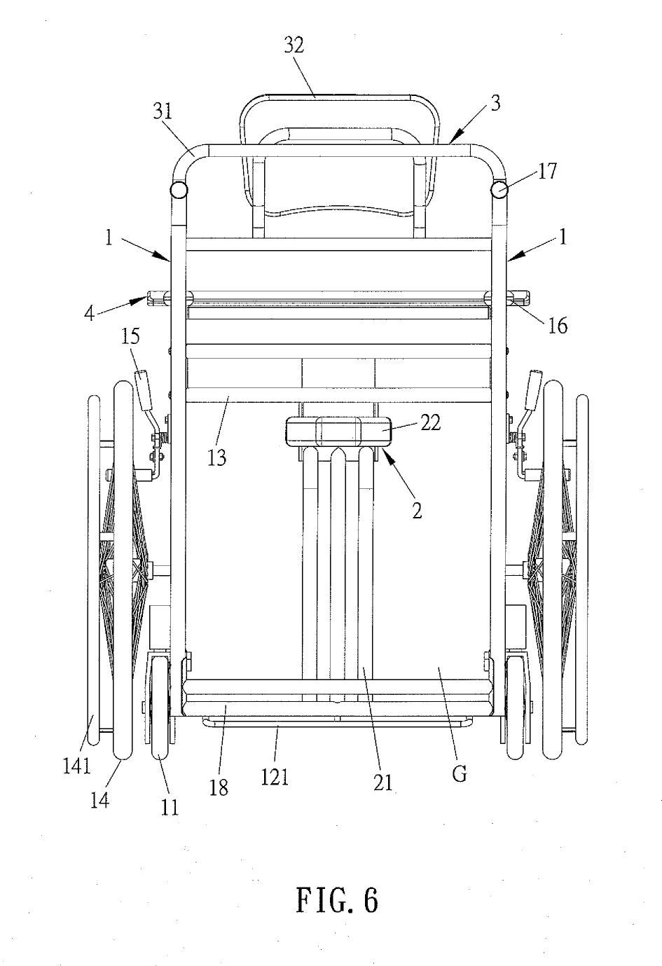

With reference to FIGS. 1-6, a backward wheelchair according to a preferred embodiment of the present invention comprises: two side-frame units 1, a seat support 2, a back support 3, and a top plate 4, wherein the two side-frame units 1 are symmetrical and spaced a distance D1 apart, each side-frame unit 1 includes an auxiliary wheel 11 mounted proximate to a lower side of a front end of each side frame 10, between two lower sides of two front ends of two side frames 10 is connected a first connecting rod 12 on which a foot plate 121 is fixed so as to put a patient's feet, and between two upper sides of the two front ends of the two side frames 10 is connected a second connecting rod 13, wherein each side frame 10 has a main wheel 14 disposed adjacent to a rear end thereof, and the main wheel 14 has a manual operating wheel 141, each side frame 10 also has a manual brake device 15 disposed on a middle section thereof proximate to the main wheel 14 (since the manual brake device is a well-known art, further remarks are omitted) and used to brake the main wheel 14, wherein the manual brake device 15 can be kept in a braking state. Each side frame 10 further has an armrest 16 mounted on an upper side of the rear end thereof and a handle 17 extending upwardly from the rear end thereof, between two lower sides of two rear ends of two side frames 10 is connected a third connecting rod 18, and between the armrest 16 and the handle 17 is defined a sleeve 19, the sleeve 19 has an orifice 191 defined therein, a cutout 192 formed on a top end of an outer peripheral wall thereof, and a through hole 193 passing through the outer peripheral wall thereof relative to the cutout 192. The seat support 2 includes an elongated body 21 connecting with a seat portion 22, one end of the elongated body 21 couples with a middle section of the second connecting rod 13, another end of the elongated body 21 connects with a middle section of the third connecting rod 18, such that the seat support 2 is fixed between the two side-frame units 1. In addition, a width D2 of the seat support 2 is less than the distance D1 between the two side-frame units 1, and the backward wheelchair further comprises a gate G formed on a rear side thereof, among the seat support 2 and the two side-frame units 1 are defined two passage spaces W. The back support 3 is fixed or rotated between the two side-frame units 1 and includes a supporting rack 31 and a cushion 32 coupled with the supporting rack 31, the supporting rack 31 has two posts 311 extending downwardly from two ends thereof, and each post 311 has an elongated aperture 3111 arranged on an outer peripheral side thereof and partially inserts into the orifice 191 of the sleeve 19 of each side-frame unit 1, and a shaft 33 selectively inserts into the through hole 193 of the sleeve 19 of each side-frame unit I or the elongated aperture 3111 of the post 311 of the supporting rack 31 (In this embodiment, the shaft 33 is a screw, a bolt, or a rivet), such that the back support 3 is fixed between the two side-frame units 1 securely so that when the patient sits on the backward wheelchair, his/her back contacts with the back support 3. Also, the top plate 4 is mounted proximate to the two upper sides of the two front ends of the two side frames 10 so that the patient places objects on the top plate 4.

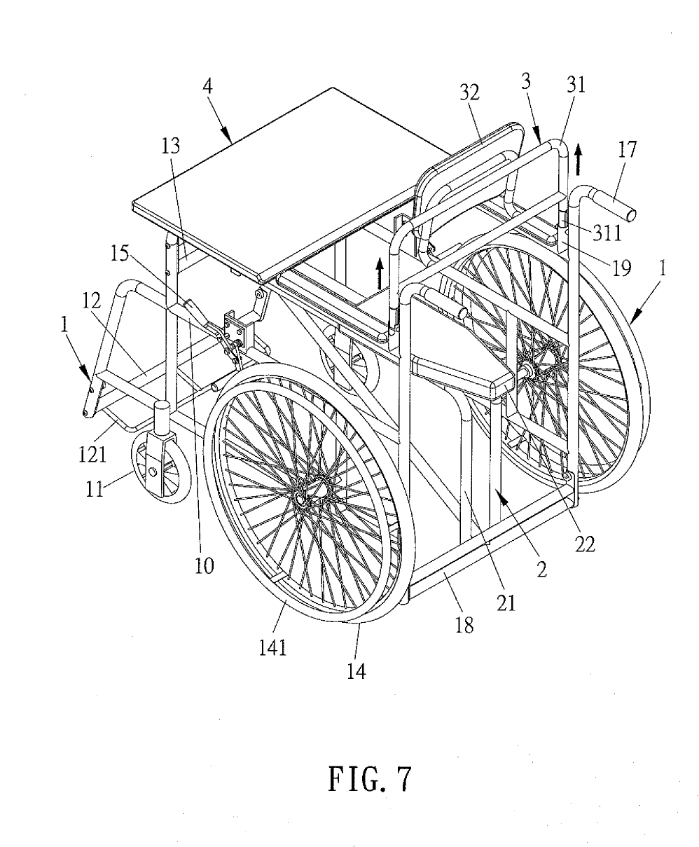

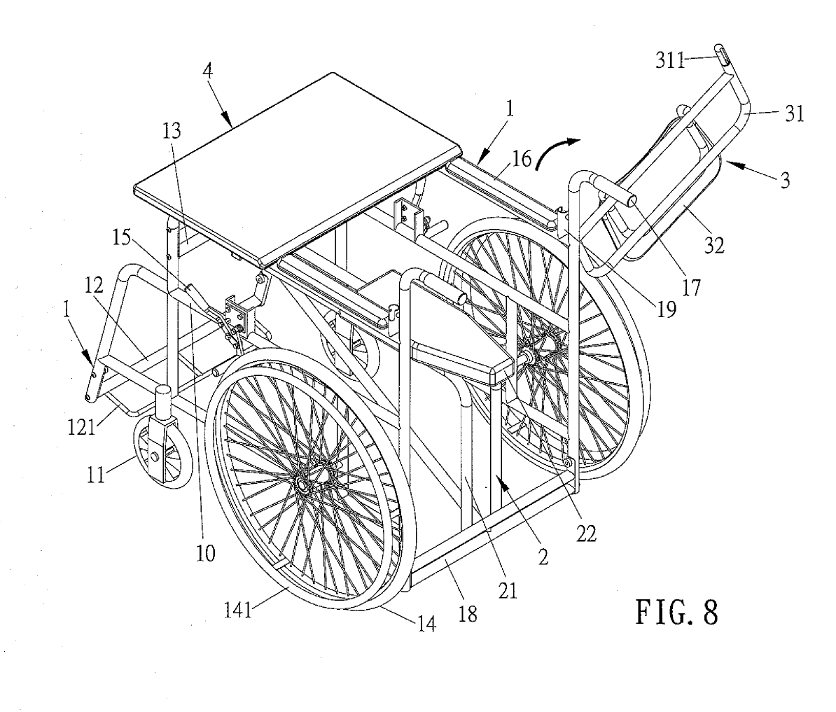

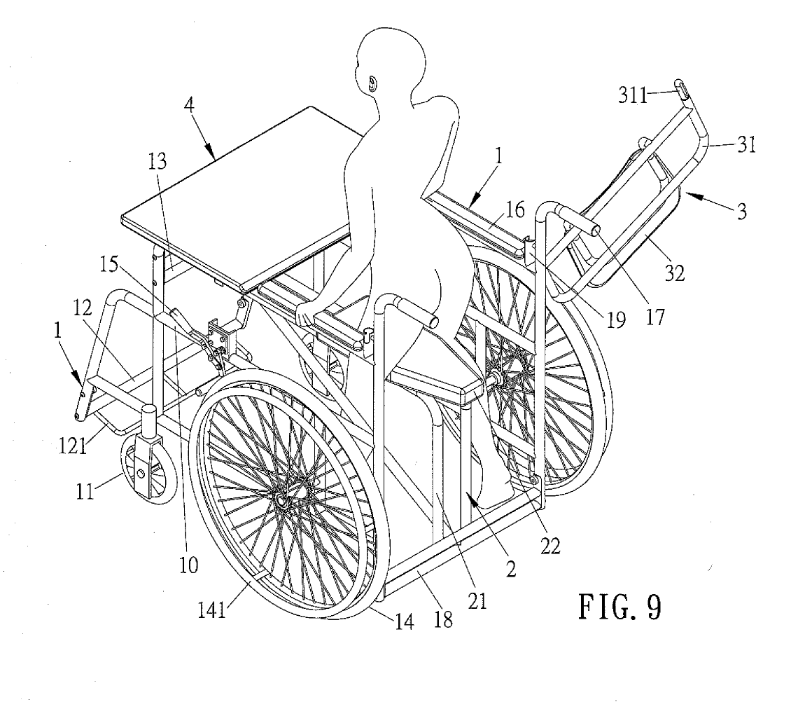

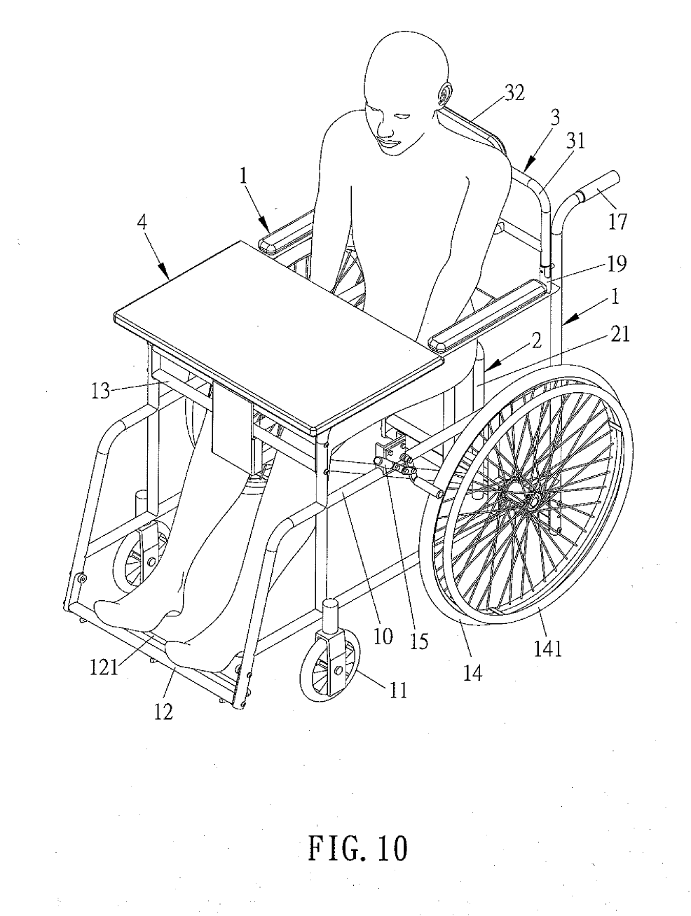

When the patient, who has paraplegia or hemiplegia, is desired to move to the seat portion 22 or a chair from a bed, as shown in FIGS. 7-10, a back side of the backward wheelchair is contacted with the bed, and then the back support 3 is pulled upwardly so that each post 311 of the supporting rack 31 of the back support 3 moves upwardly from the orifice 191 of the sleeve 19, and the shaft 33 slides to a lower end of the elongated aperture 3111 downwardly from an upper end of the elongated aperture 3111 of each post 311, such that the shaft 33 matches with the cutout 192 of the sleeve 19, thereafter the back support 3 is rotated outwardly, and the main wheel 14 is kept in the braking state by ways of the manual brake device 15, such that the patient holds the two armrests 16 of the two side-frame units 1 so as to move to and sit on the seat portion 22 of the seat support 2 from the bed or the chair via the gate G and the two passage spaces W. Thereafter, the back support 3 is rotated inwardly, and the two posts 311 of the back support 3 are partially inserted into two orifices 191 of two sleeves 19 of the two side-frame units 1 so that the back support 3 is fixed between the two side-frame units 1, hence as sitting on the seat portion 2, the patient's back contacts with the back support 3, and the manual brake device 15 is released from the barking state, so the patient moves two manual operating wheels 141 with two hands to drive the backward wheelchair to move. Furthermore, when the patient is desired to move to the bed or the chair from the backward wheelchair, the back side of the backward wheelchair is contacted with the bed or the chair, and the back support 3 is rotated outwardly, then two main wheels 14 are kept in the braking state by ways of two manual brake devices 15, such that the patient holds the two armrests 16 of the two side-frame units 1 so as to move backwardly to sit on the bed or the chair from the seat portion 22 via the gate G and the two passage spaces W.

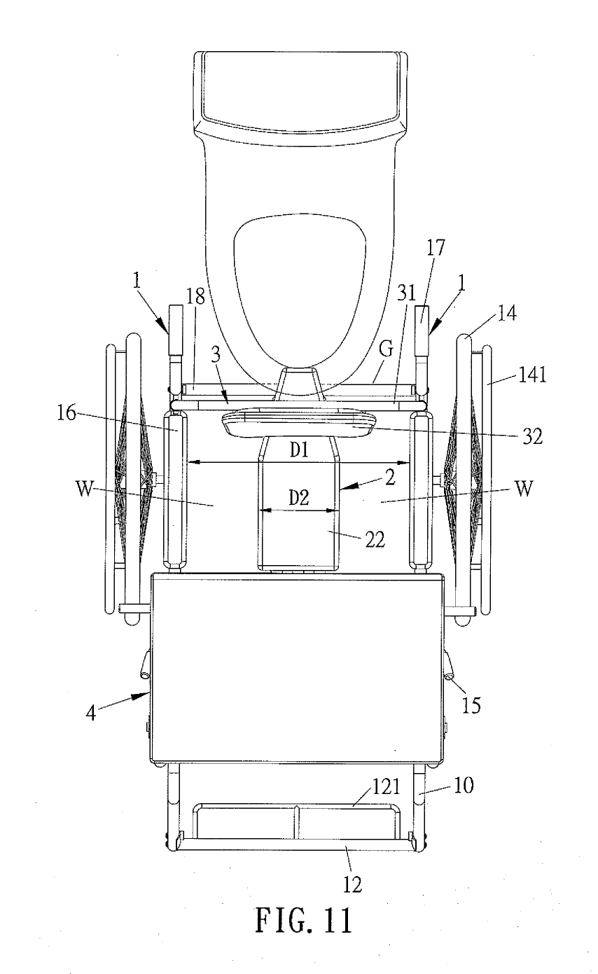

When the patient intends to move to a toilet from the backward wheelchair, as illustrated in FIG. 11, the backward wheelchair is abutted against the toilet, and then the back support 3 is rotated outwardly, thereafter the two main wheels 14 are kept in the braking state by using the two manual brake devices 15, such that the patient holds the two armrests 16 of the two side-frame units 1 so as to move backwardly to the toilet from the seat portion 22 via the gate G and the two passage spaces W.

Thereby, the backward wheelchair of the present invention has the following advantage:

In use, the back side of the backward wheelchair is contacted with the bed or the chair, and then the patient holds the two armrests 16 of the two side-frame units 1 so as to move to the backward wheelchair from the bed or the chair or to move to the bed or the chair from the backward wheelchair via the gate G and the two passage spaces W easily.

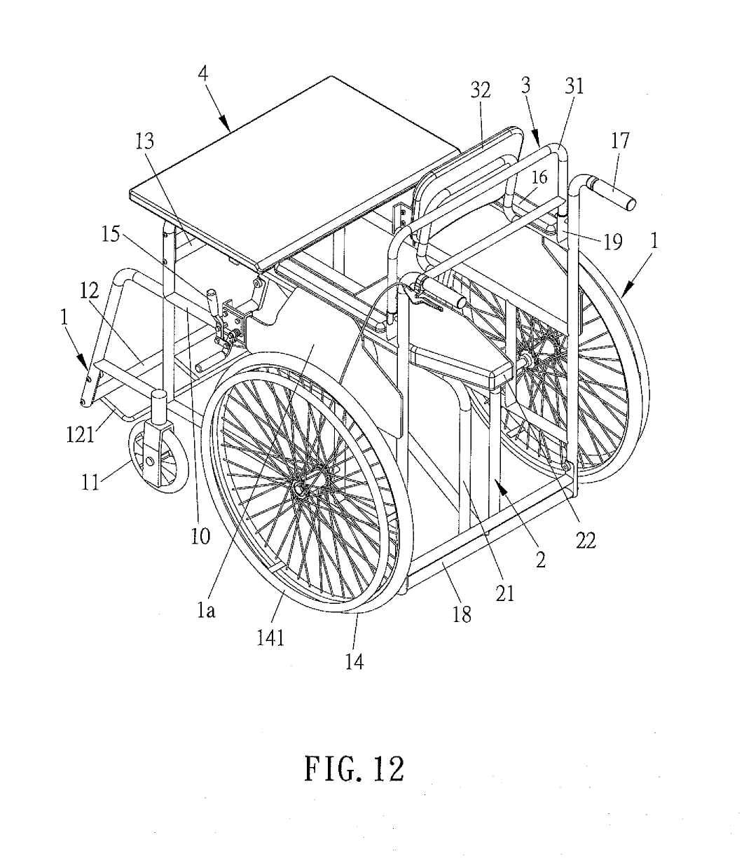

Referring further to FIG. 12, a backward wheelchair according to another embodiment of the present invention comprises a protective sheet 1a mounted among the two side frames 10 and the two main wheels 14 of two side-frame units 1 so as to protect the patient.

While we have shown and described various embodiments in accordance with the present invention, it is clear to those skilled in the art that further embodiments may be made without departing from the scope of the present invention.

What is claimed is:

1. A backward wheelchair comprising:
two side-frame units being symmetrical and spaced a distance apart, between the two side-frame units being connected a first connecting rod, each side-frame unit including an auxiliary wheel mounted proximate to a lower side of a front end of each side frame, each side frame having a main wheel disposed adjacent to a rear end thereof, and the main wheel having a manual operating wheel, each side frame further having an armrest mounted on an upper side of the rear end thereof and a handle extending upwardly from the rear end thereof;
a seat support including an elongated body connecting with a seat portion, the seat support being fixed between the two side-frame units, a width of the seat support being less than the distance between the two side-frame units, the backward wheelchair further comprising a gate formed on a rear side thereof, among the seat support and the two side-frame units being defined two passage spaces;
a back support fixed or rotated between the two side-frame units so as to facilitate a movement of a patient, and the patient's back contacts with the back support.

2. The backward wheelchair as claimed in claim 1, wherein between two lower sides of two front ends of two side frames is connected a first connecting rod, and between two upper sides of the two front ends of the two side frames is connected a second connecting rod, between two lower sides of two rear ends of two side frames is connected a third connecting rod.

3. The backward wheelchair as claimed in claim 2, wherein a first connecting rod has a foot plate fixed thereon so as to put a patient's feet.

4. The backward wheelchair as claimed in claim 1, wherein each side frame also has a manual brake device disposed on a middle section thereof proximate to the main wheel so as to brake the main wheel, and the manual brake device can be kept in a braking state.

5. The backward wheelchair as claimed in claim 1, wherein the back support includes a supporting rack and a cushion coupled with the supporting rack, the supporting rack has two posts extending downwardly from two ends thereof, and each post has an elongated aperture arranged on an outer peripheral side thereof and partially inserts into the orifice of the sleeve of each side-frame unit, a shaft is insert into the through hole of the sleeve of each side-frame unit and the elongated aperture of the post of the supporting rack.

6. The backward wheelchair as claimed in claim 2, wherein one end of the elongated body couples with a middle section of the second connecting rod, another end of the elongated body connects with a middle section of the third connecting rod.

7. The backward wheelchair as claimed in claim 1 further comprising a top plate mounted proximate to the two upper, sides of the two front ends of the two side frames.
